(19) United States
(12) Patent Application Publication
(10) Pub. No.: US 2004/0238019 A1
(43) Pub. Date: Dec. 2, 2004

(54) Cleaning and/or disinfection device for a cryostat

(76) Inventor: Stefan Kuenkel, Karlsruhe (DE)

Correspondence Address: HODGSON RUSS LLP, ONE M & T PLAZA, SUITE 2000, BUFFALO, NY, 14203-2391, US

(21) Appl. No.: 10/848,400

(22) Filed: May 18, 2004

(30) Foreign Application Priority Data
May 28, 2003 (DE) 103 24 646.0

(51) Int. Cl. B08B 3/00

(52) U.S. Cl. 134/115 R; 134/105

(57) ABSTRACT

A cryostat (1), having a container (2) for receiving a microtome, is described. Provided in the cryostat (1) is a cleaning and/or disinfection device that comprises at least one spray nozzle and a pump (5) for spraying a cleaning and/or disinfection liquid in the container (2). The cryostat (1) is equipped with a control circuit (6) for activating the pump (5), at least one of the spray nozzles being embodied as a swirl nozzle (4) having a spray angle of 360°.

### CROSS REFERENCE TO RELATED APPLICATIONS

This application claims priority of the German patent application 103 24 646.0 filed May 28, 2003 which is incorporated by reference herein.

### FIELD OF THE INVENTION

The invention concerns cryostats of a type having a container for receiving a microtome, and more particularly to cleaning devices for cryostats.

### BACKGROUND OF THE INVENTION

Cryostat microtomes are designed so that specimens that are to be cut are cooled to a specific predetermined temperature. The temperatures are, as a rule, between −10° and −50° C. To ensure a constant temperature, the microtomes are arranged in extensively encapsulated housings. A stainless-steel container for receiving the microtome is provided in the interior of the housing. The cryostat moreover has a closable viewing window through which the user gains access to the container and the interior.

During microtome operation, cutting waste also inevitably occurs and must be removed from the cryostat from time to time. Since the cutting waste that occurs may also be biologically or chemically contaminated, a disinfection of the housing interior is also performed upon cleaning of the cryostat.

This cleaning and disinfection has hitherto been performed manually, a cleaning and/or disinfection liquid being, for example, sprayed with a spray bottle into the interior of the cryostat. This manual method has proven successful but of course is very time-consuming.

DE 88 14 284 U1 discloses a cryostat that comprises a cutting waste pan filled with a disinfection agent. This waste pan extends only over a small region within the cryostat, however, so that complete cleaning and/or disinfection is not possible.

An automatic disinfection system for a cryostat is known from the document “Standkryostat MNT [MNT upright cryostat]” of the Slee company, Mainz (no publication date). Arranged in this cryostat are two spray nozzles which are connected to a pump and through which the cleaning and disinfection liquid is sprayed in program-controlled fashion into the interior of the cryostat.

It has been found in practical use, however, that the arrangement of the nozzles and the type of nozzle used are not suitable for completely wetting the interior with cleaning and disinfection liquid, and subsequent manual treatment with a spray bottle is thus necessary.

### SUMMARY OF THE INVENTION

It is therefore the object of the present invention to improve the cleaning and/or disinfection operation within the cryostat and to ensure complete and reliable cleaning and disinfection even in corners and inaccessible areas.

The invention is characterized in that the nozzle arranged in the interior of the cryostat is embodied as a swirl nozzle having a spray angle of 360°. As a result, the cleaning and/or disinfection liquid is distributed homogeneously in the entire interior of the cryostat.

In a development of the invention, the swirl nozzle has a tube that is bent 180°. The open tube end is directed onto a plate so that the liquid is sprayed under high pressure, e.g. 15 bar, onto the plate, and is homogeneously deflected there in all directions.

In a further embodiment of the invention, the tube has an inside diameter of approximately 0.1 mm. As a result, only a very fine jet is directed onto the plate and can be atomized there in finely distributed fashion.

In a development of the invention, a filter for filtering the cleaning and/or disinfection liquid is associated with the pump. Suspended material or contaminants present in the cleaning and disinfection liquid are thereby filtered out. This is necessary in order to prevent clogging of the very fine nozzle.

In a further embodiment of the invention, the control circuit is equipped with an automatic time controller. As a result, in addition to a manually initiated cleaning and/or disinfection, an automatic, time-controlled, and unattended cleaning and/or disinfection can also be accomplished. In an embodiment of the invention, the automatic cleaning and/or disinfection is preceded by an automatic defrosting of the cryostat. This is necessary in order to remove the ice that has formed, thus making possible effective cleaning of parts in the container that are usually ice-covered, e.g. the evaporator.

In a development of the invention, a safety switch is associated with the closable viewing window and is electrically connected to the control circuit. This ensures that cleaning and disinfection can occur only when the cryostat is closed. Otherwise the risk exists that the cleaning and disinfection liquid might emerge from the unit and thereby harm the operator. In addition, the liquid is usually slightly flammable at room temperature and a risk of fire or explosion thus exists.

In a further embodiment of the invention, a temperature sensor is arranged in the container and is electrically connected to the control circuit. By way of the sensor, the temperature in the container is measured and the cleaning and disinfection operation is initiated only when the temperature has not exceeded and/or fallen below a specific minimum temperature. The different cleaning and disinfection liquids have an optimum cleaning and disinfection effect only within a specific temperature range, which lies e.g. between 0° and −20° Celsius. Below −20° the cleaning and disinfection effect exists to only a limited extent, while above 0° the liquid can be combustible.

In a development of the invention, a fill level indicator is provided for indicating the quantity of cleaning and/or disinfection liquid that is present. The fill level indicator is electrically connected to the control circuit. As a result, the pump is activated only when the liquid quantity is sufficient, and corresponding acoustic and/or optical notifications are issued or corresponding displays are controlled.

In a further embodiment of the invention, provision is made for the cleaning and/or disinfection to be deactivated, by way of the control device, when the safety switch responds and/or when a preselected temperature is reached and/or when a preselected temperature range is exceeded and/or when the fill level falls below a preselected value, so as thereby to ensure reliable and effective cleaning and/or disinfection of the cryostat.

In a development of the invention, a swirl nozzle is arranged in each of the two front corners of the container. At least one further swirl nozzle is provided on the back wall of the container. This ensures reliable wetting of the entire internal container with liquid.

### BRIEF DESCRIPTION OF THE DRAWINGS

The invention will be explained in more detail with reference to an exemplary embodiment with the aid of the schematic drawings in which:

FIG. 1 is a view of the cryostat;

FIG. 2 is a view of the container in the cryostat with the swirl nozzles in place; and

FIG. 3 is a view of the swirl nozzle.

### DETAILED DESCRIPTION OF THE INVENTION

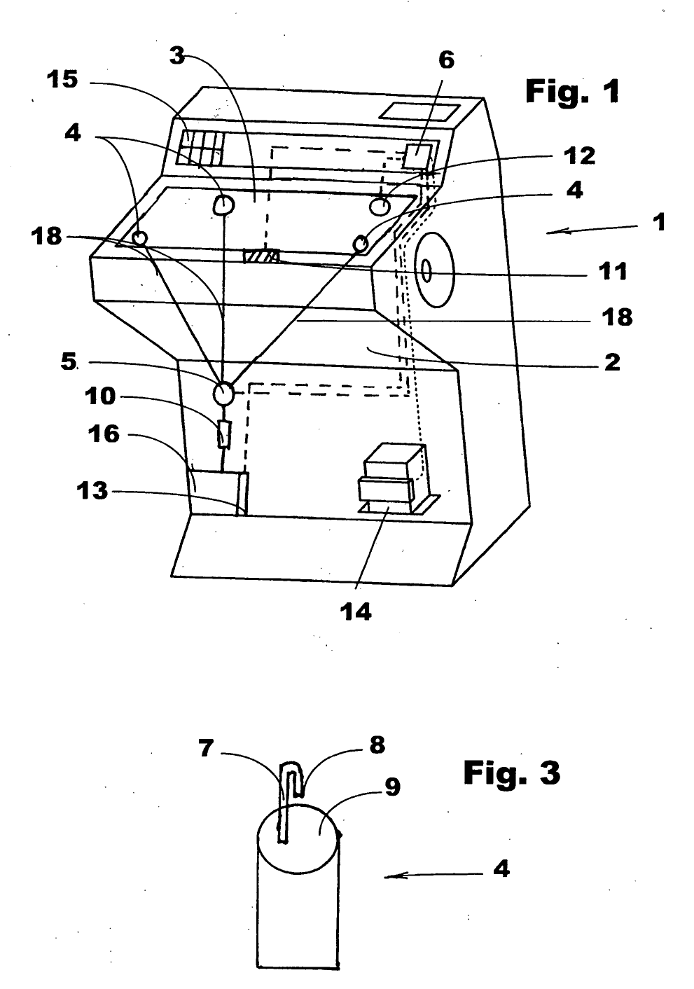

FIG. 1 is a view of cryostat 1 with a container 2 and a viewing window 3 that can close off the container 2. Arranged in container 2 are swirl nozzles 4 of a cleaning and/or disinfection device that are connected via, lines 18 to a pump 5, an upstream filter 10, and a liquid container 16.

A control console 15, and a control circuit 6 that is connected to a power supply 14, are provided in the cryostat. Control circuit 6 is electrically connected to pump 5, so that pump 5 is activated via control circuit 6 and the cleaning and/or disinfection liquid can then be pumped out of liquid container 16 and transported through filter 10 and lines 18 to swirl nozzles 4. The liquid is then sprayed homogeneously in container 2 through swirl nozzles 4.

Associated with viewing window 3 is a safety switch 11 with which the opening and closing of viewing window 3 are recorded. The safety switch is electrically connected to control circuit 6, where the signal of safety switch 11 is evaluated and pump 5 is deactivated when viewing window 3 is open.

A fill level indicator 13, which is electrically connected to control circuit 6, is associated with liquid container 16. When the liquid level is too low, pump 5 is switched off via control circuit 6.

A temperature sensor 12 is also arranged in container 2 of cryostat 1 and is electrically connected to control circuit 6. The internal temperature of cryostat 1 measured by temperature sensor 12 is evaluated in control circuit 6 with regard to a minimum and maximum permissible temperature, and outside that temperature range pump 5 is deactivated. This is necessary because the various agents have a complete cleaning and disinfection effect only until a certain temperature is reached. Below that temperature, e.g. −20°, ice formation can occur on swirl nozzles 4. Since the cleaning and/or disinfection agents usually contain flammable substances, a maximally permissible maximum temperature within cryostat 1 must not be exceeded. Otherwise a risk of fire exists.

These temperature ranges of course depend on the liquids used, and the temperature ranges are individually selectable via control console 15. When non-critical liquids are being used, for example, it is of course also conceivable for maximum temperature limits not to be defined.

By way of the control console 15, a manually initiated immediate or automatic time-controlled cleaning and disinfection of the cryostat can be selected. The automatic time-controlled cleaning and disinfection is preferably accomplished outside the usual operating periods of the cryostat, preceded by defrosting of the ice that has formed. This ensures that even inaccessible areas in the cryostat, e.g. the cooling coils that are usually covered with ice, are reliably cleaned and disinfected. For this purpose, control circuit 6 includes an automatic time controller.

FIG. 2 is a view of container 2 with swirl nozzles 4 arranged on a pedestal 17. The height of pedestal 17 is selected so that optimum distribution of the sprayed liquid occurs.

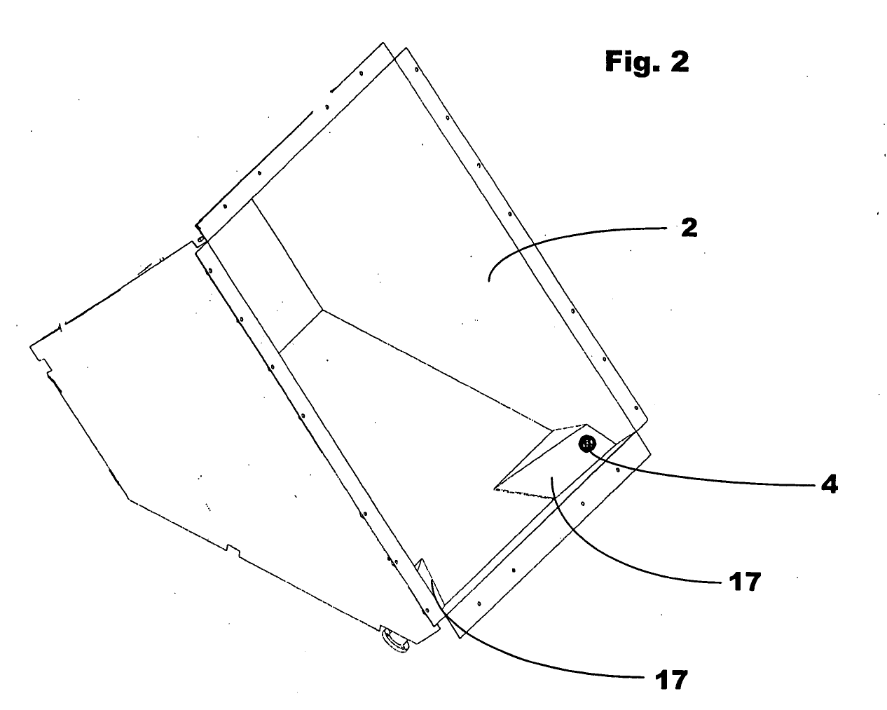

FIG. 3 is a view of swirl nozzle 4 with tube 7 that is bent 180°. Open tube end 8 is directed onto a plate 9 so that the liquid, sprayed out under high pressure, is homogeneously deflected by plate 9. Usual quantities for cleaning and for disinfection are approximately 10 ml of liquid, which is sprayed over a time span of approximately 15 seconds at a pressure of approximately 15 bar through the tube that is approximately 0.1 mm wide.

Parts List

1 Cryostat

2 Container

3 Viewing window

4 Swirl nozzle

5 Pump

6 Control circuit

7 Tube

8 Tube end

9 Plate

10 Filter

11 Safety switch

12 Temperature sensor

13 Fill level indicator

14 Power supply

15 Control console

16 Liquid container

17 Pedestal

18 Lines

What is claimed is:

1. A cryostat comprising:
a container for receiving a microtome; and
a cleaning and/or disinfection device including a pump for providing a flow of cleaning and/or disinfecting liquid, a spray nozzle in communication with the pump for spraying the cleaning and/or disinfection liquid within the container, and a control circuit operatively connected to the pump for activating the pump,
wherein the spray nozzle is a swirl nozzle having a spray angle of 360°.

2. The cryostat as defined in claim 1, further comprising a plate associated with the swirl nozzle, wherein the swirl nozzle includes a tube having a 180° bend and an open discharge end directed at the plate.

3. The cryostat as defined in claim 2, wherein the inside diameter of the tube is approximately 0.1 mm.

4. The cryostat as defined in claim 1, further comprising a filter associated with the pump for filtering the cleaning and/or disinfection liquid.

5. The cryostat as defined in claim 1, wherein the control circuit has an automatic time controller.

6. The cryostat as defined in claim 1, wherein the container includes a viewing window capable of being opened and closed and a safety switch associated with the viewing window to indicate when the viewing window is opened, wherein the safety switch is electrically connected to the control circuit.

7. The cryostat as defined in claim 1, further comprising a temperature sensor arranged in the container and electrically connected to the control circuit.

8. The cryostat as defined in claim 1, further comprising a liquid container for storing the cleaning and/or disinfecting liquid and a fill level indicator associated with the liquid container for indicating the quantity of cleaning and/or disinfection liquid present in the liquid container, wherein the fill level indicator is electrically connected to the control circuit.

9. The cryostat as defined in claim 6, wherein the pump is deactivated by the control circuit when the safety switch indicates that the viewing window is opened.

10. The cryostat as defined in claim 7, wherein the pump is deactivated by the control circuit when the temperature sensor indicates the temperature in the container is outside a predetermined permissible temperature range.

11. The cryostat as defined in claim 8, wherein the pump is deactivated by the control circuit when the fill level indicator indicates the fill level is below a preselected value.

12. The cryostat as defined in claim 1, wherein the container is generally rectangular and includes a front wall, a back wall, a pair of side walls connecting the front wall and the back wall, and a pair of front corners defined by the front wall and pair of side walls, and wherein a swirl nozzle is arranged in each of the pair of front corners of the container and at least one further swirl nozzle is arranged on the back wall of the container.

13. The cryostat as defined in claim 5, wherein the automatic time controller is operable to initiate an automatic defrosting cycle followed by an automatic cleaning and/or disinfection cycle.
